(19) United States
(12) Patent Application Publication
(10) Pub. No.: US 2012/0096462 A1
(43) Pub. Date: Apr. 19, 2012

(54) DYNAMIC VIRTUALIZATION TECHNIQUE FOR MULTICORE PROCESSOR SYSTEM

(75) Inventor: Taeho KIM, Gyeonggi-Do (KR)

(73) Assignee: Electronics and Telecommunications Research Institute, Daejeon (KR)

(21) Appl. No.: 13/274,492

(22) Filed: Oct. 17, 2011

(30) Foreign Application Priority Data
Oct. 18, 2010 (KR) 10-2010-0101174
May 20, 2011 (KR) 10-2011-0047667

(51) Int. Cl. G06F 9/455

(52) U.S. Cl. 718/1

(57) ABSTRACT

Disclosed is a method of allocating OS resources in a multicore processor system, including: setting a common operating system (OS) layer serving to process a common resource; setting a partitioned OS layer allocating one or more partitioned OSs to each of multiple cores; and reallocating the partitioned OSs allocated to the multiple cores in the partitioned OS layer on the basis of system resources required to drive each OS.

### CROSS-REFERENCE TO RELATED APPLICATIONS

This application is based on and claims priority from Korean Patent Application No. 10-2010-0101174, filed on Oct. 18, 2010, and Korean Patent Application No. 10-2011-0047667, filed on May 20, 2010, with the Korean Intellectual Property Office, the present disclosure of which is incorporated herein in its entirety by reference.

### TECHNICAL FIELD

The present disclosure relates to a method of dynamically changing a partition in a virtualization system with a multicore processor. More particularly, the present disclosure relates to a method of dynamically allocating resources by using a partitioned operating system (OS) layer in a multicore processor system.

### BACKGROUND

A virtualization system is a technology that has a layer such as a hypervisor on one processor and operates one or more operating system thereon. This technology is a method for improving the reliability of the system by stopping propagation of error by maintaining independence of each operating system.

In recent years, as a processor has been developed as a multicore. a computing environment has been changed. A core means another processing subject unit in a CPU which is independently operated within a central processing unit (CPU). A multicore system having a plurality of cores can adjust a workload by allocating works per core. However, in the multicore system, a study about a technique that dynamically virtualizes the workload is insufficient.

Accordingly, the present disclosure intends to provide a structure and a method in which the virtualization system can operate in the multicore system.

### SUMMARY

The present disclosure has been made in an effort to provide a virtualization technique suitable for a multicore processor structure. In particular, the present disclosure has been made in an effort to provide a method that can dynamically partition resources with respect to a multicore processor in using multiple operating systems.

Further, the present disclosure has been made in an effort to provide a method of allocating a system resource to improve the performance of the multicore processor system by efficiently managing the system resource with respect to the multiple operating systems.

An exemplary embodiment of the present disclosure provides a method of allocating OS resources in a multicore processor system, including: setting a common operating system (OS) layer serving to process a common resource; setting a partitioned OS layer allocating one or more partitioned OSs to a multiple cores; and reallocating the partitioned OSs allocated to the multiple cores in the partitioned OS layer on the basis of system resources required to drive each OS.

The common OS layer may perform at least one function of global memory management and common device management.

The partitioned OS layer may independently manage resources of a local memory.

The multiple OSs may be partitioned and allocated to one core.

The resources may be dynamically reallocated to the multiple cores by reallocation of the partitioned OS in the partitioned OS layer.

According to the exemplary embodiments of the present disclosure, since resources can be dynamically allocated per unit of each partitioned OS, set OS resources can be effectively OS-allocated over a range.

According to the exemplary embodiment of the present disclosure, by dynamically managing a system resource with respect to plurality of OSs, the performance of a multicore processor system can be improved and system efficiency can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram showing a virtualization configuration in a multicore processor system in the related art.

FIG. 2 is a conceptual diagram showing an operating system (OS) partitioned in a multicore processor system according to an exemplary embodiment of the present disclosure.

FIG. 3 is a conceptual diagram showing an operating system (OS) reallocated in a multicore processor system according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

FIG. 1 is a diagram showing a virtualization configuration in a multicore processor system in the related art.

Referring to FIG. 1, a processor 110, a virtualization layer 120, and an OS layer 130 are shown in the multicore processor system.

As shown in FIG. 1, processor 110 is constituted by N cores including core 1 111, core 2 112, and core 3 113 and virtualization layer 130 is mounted on processor 110.

OS layer 130 is constituted by M partitioned OS units including OS 1 131, OS 2 132, and OS 3 133 and as shown in FIG. 1, OS 1 is allocated to core 1 and core 2, OS 2 and OS 3 are allocated to core 3, and OS M is allocated to core N. As such, one OS may be allocated to multiple cores and in addition, plurality of OSs may be allocated to one core.

However, in the multicore processor system in the related art shown in FIG. 1, virtualization layer 120 allocates OSs 131, 132, and 133 to respective cores 111, 112, and 113 in processor 110 in an initialization step and this allocation state is fixed and the allocation state is not changed while the system is executed. Therefore, even though a workload of an application program which operates in a predetermined OS increases or decreases, more processor abilities (alternatively, the ability of the core) cannot be allocated to the application program.

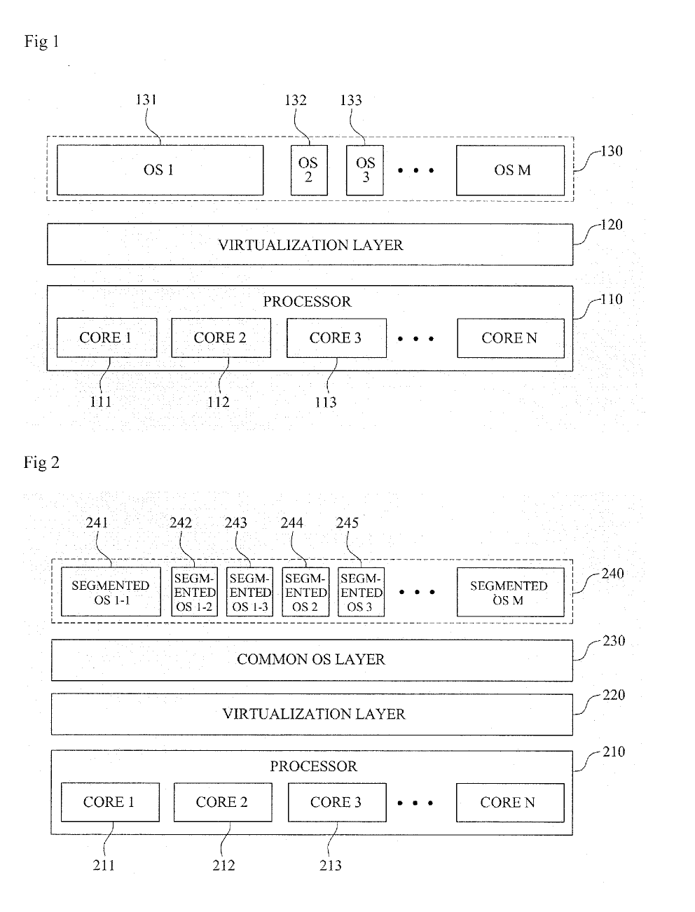

FIG. 2 is a conceptual diagram showing an operating system (OS) partitioned in a multicore processor system according to an exemplary embodiment of the present disclosure.

Referring to FIG. 2, a multicore processor 210 is constituted by N cores including core 1 211, core 2 212, and core 3 213 and a virtualization layer 220 is mounted on multicore processor 210.

On virtualization layer 220, the OS layer is separated into two and a common OS layer 230 and a partitioned OS layer 240 may be set. In such a structure, a modification in which virtualization layer 220 and common OS layer 230 are joined to be configured as one layer is possible.

Common OS layer 230 takes charge of processing of common resources such as global memory management and common device management.

Contrary to this, partitioned OS layer 230 manages independent resources of a local memory and is partitioned into plurality of partitioned OSs. The unit of the partitioned OS is one reallocatable component and resources used by each component may be dynamically changed.

Referring to FIG. 2, partitioned OS layer 240 includes partitioned OS 1-1 241, partitioned OS 1-2 242, and partitioned OS 1-3 243 constituting partitioned OS 1 and partitioned OS 2 244 and partitioned OS 3 245. Only partitioned OS 1-1 241 is allocated to core 1 211, partitioned 1-2 242 and partitioned OS 1-3 243 are allocated to core 2 212, and partitioned OS 2 244 and partitioned OS 3 245 are allocated to core 3 213. As such, the plurality of partitioned OS units may be allocated to one core, and further, several OSs may be partitioned and allocated to one core.

If partitioned OS 1 does not need more resources and partitioned OS 2 requests many resources, resources of each partitioned OS unit of partitioned OS layer 240 may be reallocated so that many resources are allocated to partitioned OS 2.

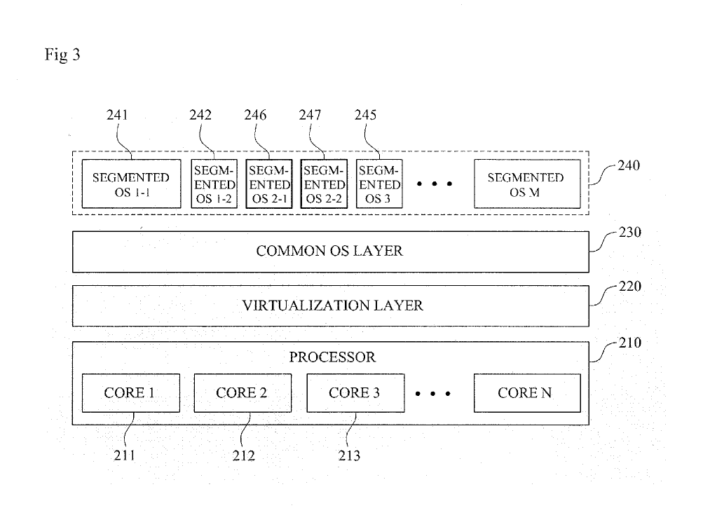

FIG. 3 is a conceptual diagram showing an operating system (OS) reallocated in a multicore processor system according to an exemplary embodiment of the present disclosure and shows a state after reallocation in partitioned OS layer 240 of FIG. 2.

Referring to FIG. 3, as a result of determining the system resources required to drive each OS, if partitioned OS 1 does not need many resources and partitioned OS 2 requests many resources, partitioned OS 1-3 243 is cancelled and partitioned OS 2-1 246 is allocated to allocate more resources to partitioned OS 2. In FIG. 2, partitioned OS 2 244 becomes partitioned OS 2-2 247 and provides resources required for partitioned OS 2 together with newly allocated partitioned OS 2-1 246 to thereby allocate more resources to a program that operates in OS 2.

That is, by reallocating the partitioned OSs allocated to multiple cores 211, 212, and 213 in partitioned OS layer 240 on the basis of the system resources required to drive each OS, the resources can be dynamically allocated to the multiple cores and the performance of the multicore processor system can be improved.

Therefore, partitioned OS 1-2 242 and partitioned OS 2-1 246 are allocated to core 2 212, such that both partitioned OS 1 and partitioned OS 2 can be allocated to core 2 212 to which only partitioned OS 1 is allocated.

As described above, the resources are allocated/released by the predetermined unit of partitioned OS, and as a result, required resources can be dynamically allocated depending on the state.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of allocating OS resources in a multicore processor system, comprising:
setting a common operating system (OS) layer serving to process a common resource;
setting a partitioned OS layer allocating one or more partitioned OSs to each of multiple cores; and
reallocating the partitioned OSs allocated to the multiple cores in the partitioned OS layer on the basis of system resources required to drive each OS.

2. The method of claim 1, wherein the common OS layer performs at least one function of global memory management and common device management.

3. The method of claim 1, wherein the partitioned OS layer independently manages resources of a local memory.

4. The method of claim 1, wherein multiple OSs are partitioned and allocated to one core.

5. The method of claim 1, wherein resources of the multiple cores are dynamically reallocated by reallocation of the partitioned OS in the partitioned OS layer.
